(19) United States
(12) Patent Application Publication
(10) Pub. No.: US 2015/0359197 A1
(43) Pub. Date: Dec. 17, 2015

(54) RETRACTABLE LEASH WITH END-OF-LEASH WARNING

(71) Applicant: CRUCS HOLDINGS, LLC, Copley, OH (US)

(72) Inventor: Kevin M. Crucs, Copley, OH (US)

(73) Assignee: CRUCS HOLDINGS, LLC, Copley, OH (US)

(21) Appl. No.: 14/692,301

(22) Filed: Apr. 21, 2015

Related U.S. Application Data
(63) Continuation-in-part of application No. 14/302,762, filed on Jun. 12, 2014.

(51) Int. Cl. A01K 27/00

(52) U.S. Cl. CPC A01K 27/009; A01K 27/004

(57) ABSTRACT

Apparatus, system, and method for providing an end-of-leash warning. Embodiments provide for determining when a retractable leash is about to reach a maximum state of detraction from a housing or reel mechanism as the leash is being detracted (e.g., by a dog), and generating a warning signal in response to determining when the retractable leash is about to reach the maximum state of detraction. The warning signal may be in the form of, for example, an emitted sonic signal, an emitted infrared signal, a transmitted radio frequency signal, or a mechanical vibration through the leash. The warning signal may be used to alert, for example, a dog and/or a person walking a dog that the leash is running out.

This application is a Continuation in Part (CIP) Application and claims priority to and the benefit of U.S. patent utility application Ser. No. 14/302,762 filed Jun. 12, 2014, which is incorporated herein by reference.

### TECHNICAL FIELD

Embodiments of the present invention relate to leashes, tethers, cords, or ropes. More particularly, certain embodiments relate to a retractable dog leash providing an end-of-leash warning.

### BACKGROUND

When walking a dog on a retractable leash, often times the dog pulls on the leash such that the leash becomes fully detracted from its housing, jerking the arm of the person walking the dog and jerking and/or choking the neck of the dog (one end of the leash being attached to the housing held by the person and the other end being attached to a collar of the dog). In such situations, neither the person walking the dog nor the dog may be aware that the retractable leash is about to run out. Therefore, it may be desirable to provide a warning to the person walking the dog and/or to the dog that the leash is about to run out. Furthermore, other mechanisms (for uses other than for walking a dog) may have a leash, cord, tether, or rope that is retractable and is coiled up within a housing or on a frame or reel device of some kind It may be desirable to provide a similar warning in such other mechanisms as well.

Further limitations and disadvantages of conventional, traditional, and proposed approaches will become apparent to one of skill in the art, through comparison of such approaches with the subject matter of the present application as set forth in the remainder of the present application with reference to the drawings.

### SUMMARY

One embodiment of the present invention comprises a system. The system includes a rotatable retracting mechanism and a leash coiled around the rotatable retracting mechanism and configured to be uncoiled from and recoiled to the rotatable retracting mechanism. The system also includes an end-of-leash detection mechanism configured to determine when the leash is nearing a maximum uncoiled state as the leash is being uncoiled. The system further includes a warning mechanism operatively connected to the end-of-leash detection mechanism and configured to generate a warning signal in response to the end-of-leash detection mechanism determining when the leash is nearing the maximum uncoiled state. The warning signal may include one or more of a mechanical vibration through the leash, an emitted sonic signal, an emitted infrared signal, or a transmitted radio frequency signal. The emitted sonic signal may be audible to dogs but not to humans.

In accordance with an embodiment, the end-of-leash detection mechanism includes a spring component and a pressure sensor. The spring component is configured to apply a determined amount of pressure to the pressure sensor when the leash is nearing the maximum uncoiled state. The pressure sensor is configured to activate the warning mechanism upon sensing the determined amount of pressure. In accordance with an embodiment, the system includes an actuator configured to attach to a dog collar. The actuator is also configured to receive the warning signal and generate an emitted sonic signal in response to receiving the warning signal. The emitted sonic signal may be audible to dogs and not to humans.

In accordance with an embodiment, the end-of-leash detection mechanism includes a spring component and the warning mechanism includes a rattle component operatively connected to the spring component. The spring component is configured to build up stored energy as the leash uncoils in response to rotation of the rotatable retracting mechanism. The spring component is further configured to release the stored energy when the leash is nearing the maximum uncoiled state. The rattle component is configured to make a rattling sound in response to the stored energy being released.

In accordance with an embodiment, the end-of-leash detection mechanism includes a switching mechanism and a bulb mechanism attached to the leash. The bulb mechanism on the leash is configured to activate the switching mechanism upon passing by the switching mechanism when the leash is nearing the maximum uncoiled state. The switching mechanism is operatively connected to the warning mechanism. The warning mechanism is configured to generate the warning signal in response to the switching mechanism being activated.

In accordance with an embodiment, the end-of-leash detection mechanism includes a sensing mechanism and a tag attached to the leash. The tag on the leash is configured to be sensed by the sensing mechanism upon passing by the sensing mechanism when the leash is nearing the maximum uncoiled state. The tag may include one of a magnetic tag, an optically encoded tag, or a radio frequency identification tag. The sensing mechanism may include one of a magnetic sensor, an optical sensor, or a radio frequency identification sensor. The sensing mechanism is operatively connected to the warning mechanism, and the warning mechanism is configured to generate the warning signal in response to the sensing mechanism sensing the tag.

One embodiment comprises an apparatus. The apparatus includes a housing and a cord residing within the housing. The apparatus also includes means for facilitating detraction of the cord from the housing and retraction of the cord back into the housing. The apparatus further includes means for determining when the cord is nearing a maximum state of detraction from the housing, and means for generating a warning signal in response to determining when the cord is nearing the maximum state of detraction from the housing. The warning signal may include one or more of a mechanical vibration through the cord, an emitted sonic signal, an emitted infrared signal, or a transmitted radio frequency signal.

One embodiment comprises a method. The method includes determining when a leash is about to reach a maximum state of detraction from a reel mechanism as the leash is being detracted from the reel mechanism. The method also includes generating a warning signal in response to determining when the leash is about to reach the maximum state of detraction from the reel mechanism. The warning signal provides an indication that the leash is about to reach the maximum state of detraction from the reel mechanism. The warning signal may include one or more of a mechanical vibration through the leash, an emitted first sonic signal, an emitted infrared signal, or a transmitted radio frequency signal. The method may further include transmitting at least a portion of the warning signal to an actuator device attached to a collar worn by a dog. The method may also include the actuator device generating and emitting a second sonic signal, that is audible to dogs and not to humans, in response to the warning signal.

These and other novel features of the subject matter of the present application, as well as details of illustrated embodiments thereof, will be more fully understood from the following description and drawings.

### BRIEF DESCRIPTION OF THE DRAWINGS

FIG. 1 illustrates a problem that can occur when walking a dog;

FIG. 2 illustrates a first example embodiment of a retractable dog leash apparatus;

FIG. 3 illustrates a magnified view of a portion of the retractable dog leash apparatus of FIG. 2;

FIG. 4 illustrates a schematic block diagram of an embodiment of a portion of the retractable dog leash apparatus of FIGS. 1-3;

FIG. 5 illustrates an example embodiment of a retractable dog leash system having both a retractable dog leash apparatus and an actuator;

FIG. 6 illustrates a portion of a second example embodiment of a retractable dog leash apparatus;

FIG. 7 illustrates the functional operation of the portion of the retractable dog leash apparatus of FIG. 6 when a leash of the retractable dog leash apparatus is connected to a collar worn by a dog;

FIG. 8 illustrates a portion of a third example embodiment of a retractable dog leash apparatus;

FIG. 9 illustrates a portion of a fourth example embodiment of a retractable dog leash apparatus;

FIG. 10 illustrates the portion of the retractable dog leash apparatus of FIG. 9 showing how a bulb mechanism interacts with a switching mechanism;

FIG. 11 illustrates a schematic block diagram of an embodiment of a portion of the retractable dog leash apparatus of FIG. 9 and FIG. 10;

FIG. 12 illustrates a portion of a fifth example embodiment of a retractable dog leash apparatus;

FIG. 13 illustrates a schematic block diagram of an embodiment of a portion of the retractable dog leash apparatus of FIG. 12;

FIG. 14 illustrates a portion of a sixth example embodiment of a retractable dog leash apparatus;

FIG. 15 illustrates the portion of the retractable dog leash apparatus of FIG. 14 showing how a trigger component interacts with a lever mechanism which interacts with a toothed component;

FIG. 16 illustrates a dog owner happily walking his dog using an embodiment of the invention of the present application; and

FIG. 17 illustrates a portion of a seventh example embodiment of a retractable dog leash apparatus.

### DETAILED DESCRIPTION

The terms “leash”, “tether”, “cord”, and “rope” may be used interchangeably herein. However, in general, the term “cord” is broader than the terms “leash”, “tether”, or “rope”. For example, a leash may be considered a type of cord. The term “housing” is used broadly herein and may refer to a substantially enclosed casing, a substantially open frame structure, or any architecture capable of storing a retractable cord. The phrases “nearing a maximum state of detraction” and “nearing a maximum uncoiled state” may be used interchangeably herein and may refer to a cord that is being pulled out of a housing that is about to run out, such that it cannot be pulled out any further from the housing, but has not yet run out. For example, a cord that is capable of being detracted fifteen feet out of a housing may be defined as nearing a maximum state of detraction when thirteen feet of the cord has been detracted from the housing.

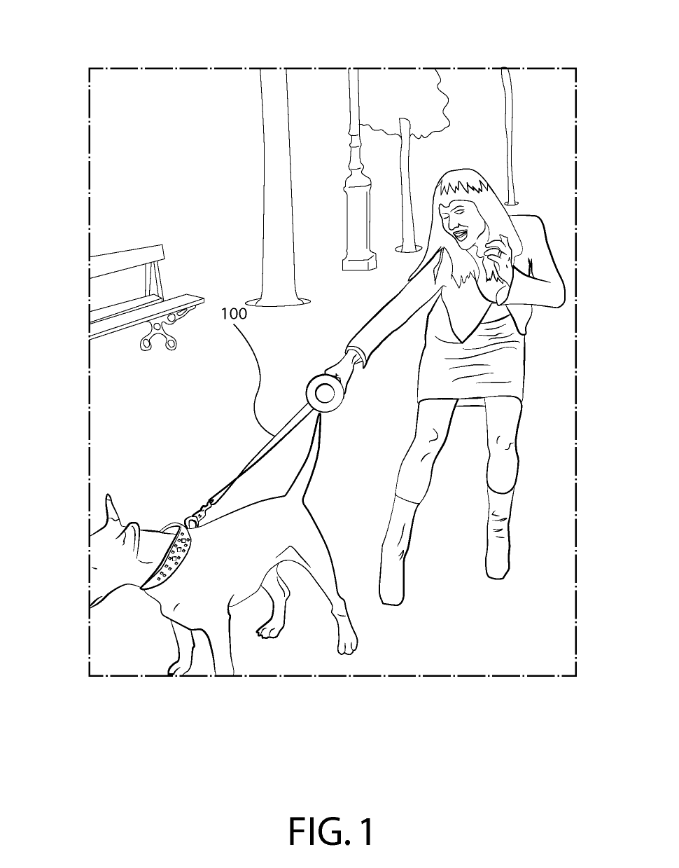

FIG. 1 illustrates a problem that can occur when walking a dog. When walking a dog on a retractable leash 100, often times the dog pulls on the leash such that the leash becomes fully detracted from its housing, jerking the arm of the person walking the dog and jerking and/or choking the neck of the dog (one end of the leash being attached to the housing held by the person and the other end being attached to a collar of the dog). In such situations, neither the person walking the dog nor the dog may be aware that the retractable leash is about to run out. Therefore, it is desirable to provide a warning to the person walking the dog, and/or to the dog, that the leash is about to run out.

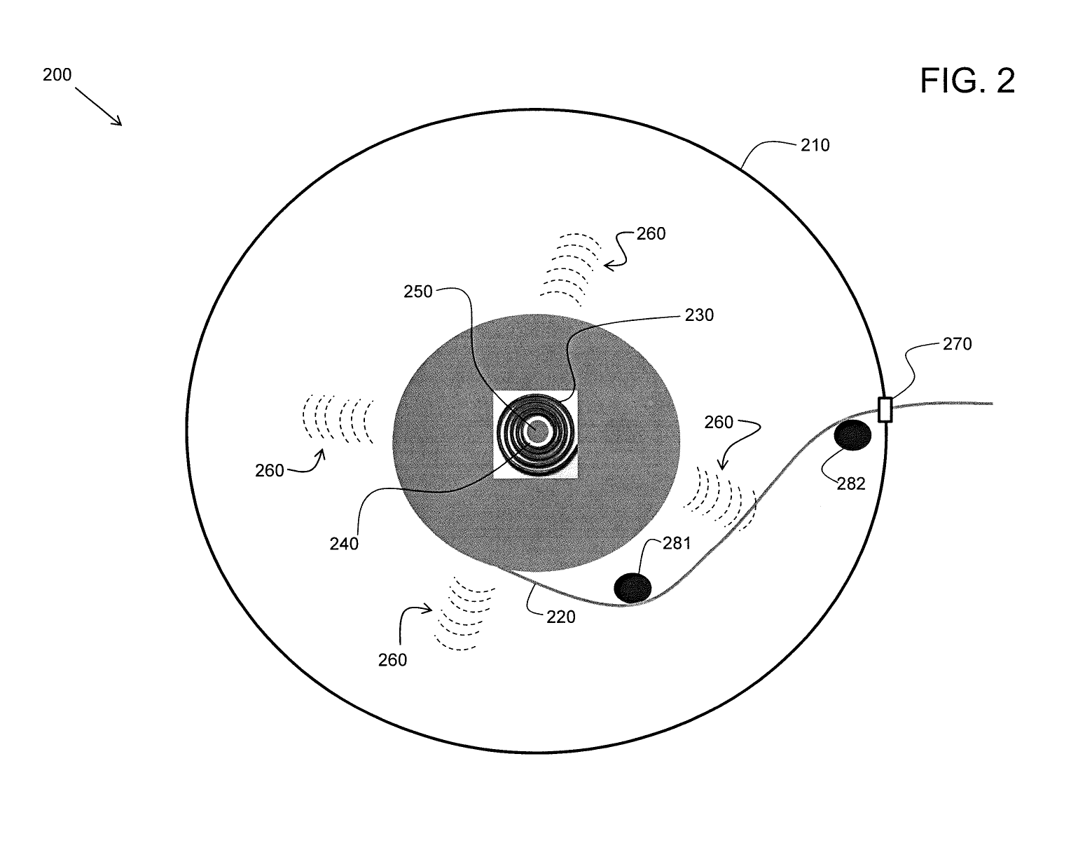

FIG. 2 illustrates a first example embodiment of a retractable dog leash apparatus 200. The apparatus 200 includes a housing 210, a retractable leash 220 that may be coiled to and uncoiled from the housing 210 in a rotating manner, a spring component 230 (e.g., a spiral torsion spring), a pressure sensor 240, and a warning mechanism (e.g., a sound emitter or a radio frequency transmitter) 250 configured to emit an audio or radio frequency signal 260. The spring component 230 and the pressure sensor 240 constitute an end-of-leash detection mechanism as discussed in more detail later herein. The leash 220 may exit from the housing and retract back into the housing via a port 270 along roller guides 281 and 282, for example.

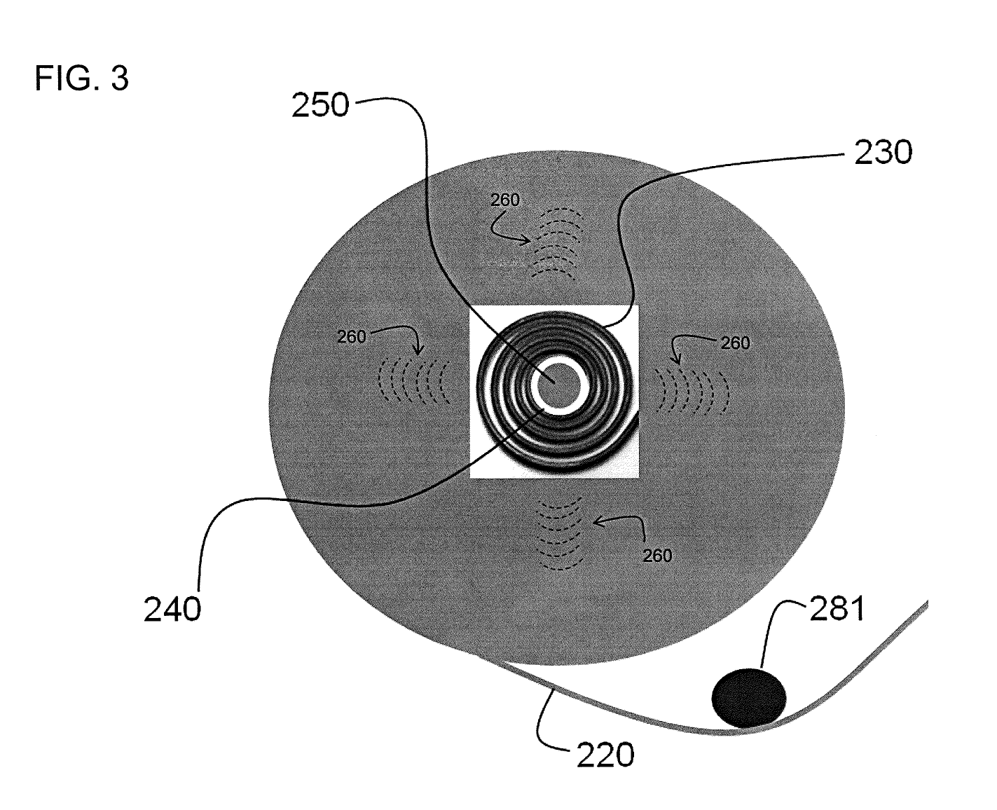

FIG. 3 illustrates a magnified view of a portion of the retractable dog leash apparatus 200 of FIG. 2. In accordance with an embodiment, as the leash 220 is detracted from the housing 210 in a rotating manner, the spring component 230 tightens around the pressure sensor 240 due to the rotation. At a certain point (the end-of-leash warning point), the spring component 230 applies enough pressure to the pressure sensor 240 causing the pressure sensor 240 to output an activating signal to the warning mechanism 250. The activating signal causes the warning mechanism 250 to activate, generating and emitting a sound (or generating and transmitting a radio frequency signal, in accordance with an alternative embodiment).

The apparatus 200 is designed such that the end-of-leash warning point (EOLWP) corresponds to the point where the leash 220 is mostly detracted from the housing 210 and is about to run out. That is, the leash 220 is nearing a maximum state of detraction (e.g., nearing a maximum uncoiled state) from the housing 210. For example, a leash that is capable of being detracted twenty feet out of a housing may be designed as nearing a maximum state of detraction when fifteen feet of the leash has been detracted from the housing.

When the warning mechanism 250 emits the sound, the emitted sound 260 alerts the dog at the other end of the leash that the leash is about to run out. As a result, the dog becomes trained to associate the emitted sound with the leash nearing a maximum state of detraction. When the dog is trained (e.g., after several walks with the owner using the apparatus 200), the dog will learn to stop or back off from pulling on the leash when hearing the emitted sound. In this manner, the leash will not totally run out and the arm of the person walking the dog will not be jerked (and the neck of the dog will not be jerked or choked).

In accordance with an embodiment, the emitted sound 260 may be audible to both the person walking the dog (a human) and the dog itself. In accordance with another embodiment, the emitted sound 260 may be audible to the dog but not the human. The warning mechanism 250 may be designed to emit a sound that is annoying to the dog, thus making it more likely that the dog will be trained more quickly to stop or back off from pulling on the leash.

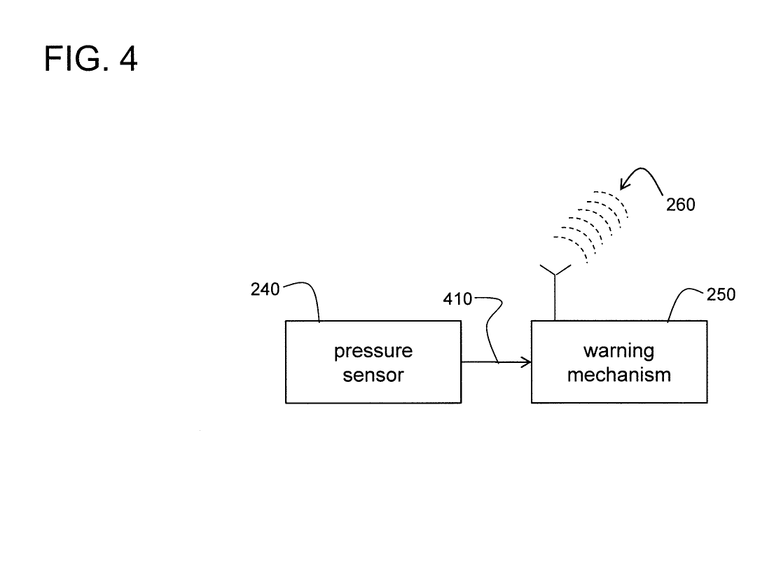

FIG. 4 illustrates a schematic block diagram of an embodiment of a portion of the retractable dog leash apparatus 200 of FIGS. 1-3. The pressure sensor 240 is operatively connected to the warning mechanism 250 such that the pressure sensor 240 outputs an activating signal 410 (e.g., an electrical signal) to the warning mechanism 250 when the leash 220 is nearing a defined maximum state of detraction. The pressure sensor 240 acts as a transducer and generates the activating signal 410 when a certain amount of pressure (e.g., a force) is imposed by the spring component 230 on the pressure sensor 240. The pressure sensor 240 may employ any of a number of pressure-sensing or force-sensing technologies including but not limited to piezoresistive, piezoelectric, capacitive, optical, and electromagnetic.

In accordance with an embodiment, the warning mechanism 250 may include a sound emitter. For example, the activating signal 410 may trigger a sonic oscillator to activate within the sound emitter. The sonic oscillator may produce a frequency that is audible to both humans and dogs, or just dogs. The sound emitter may include a power source (e.g., a small battery) to power the oscillator. In accordance with an embodiment, the power source may be kept charged by an energy harvesting device that harvests mechanical energy from the rotating motion of the apparatus, as the leash is uncoiled and recoiled, and converts the mechanical energy to electrical energy which is stored in the power source (e.g., a small battery).

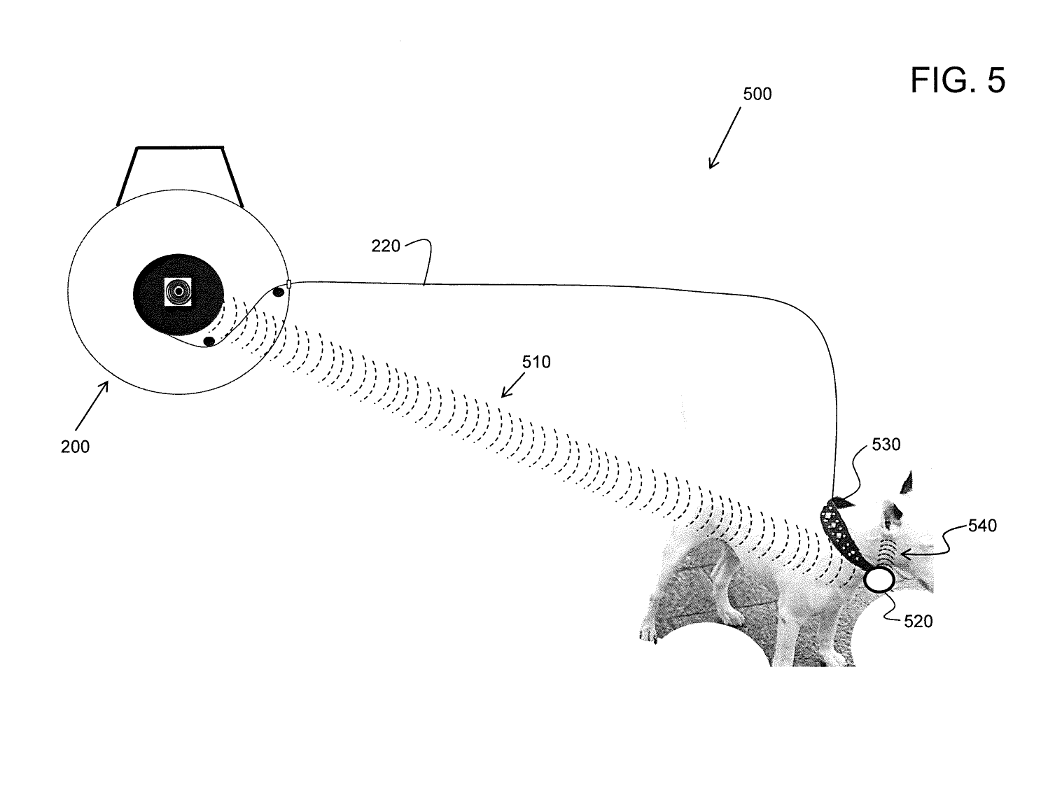

In accordance with another embodiment, the warning mechanism 250 may include a radio frequency transmitter. For example, the activating signal 410 may trigger a radio frequency oscillator to activate within the radio frequency transmitter. The radio frequency oscillator may produce an electromagnetic wave 510 (see FIG. 5) that propagates away from the apparatus 200 at a radio frequency that is capable of being received by an actuator 520 attached to a collar 530 of the dog being walked. The radio frequency transmitter may include a power source (e.g., a small battery) to power the oscillator.

FIG. 5 illustrates an example embodiment of a retractable dog leash system 500 having both the retractable dog leash apparatus 200 and the actuator 520. When the leash 220 is nearing the defined maximum state of detraction (i.e., the EOLWP), the radio frequency signal 510 is transmitted by the warning mechanism 250 and received by the actuator 520. The received radio frequency signal 510 activates the actuator 520, causing the actuator to emit a sonic signal 540 that is audible to the dog, which alerts the dog at the other end of the leash that the leash is about to run out. The actuator 520 may include a power source (e.g., a small battery) to power the actuator.

In accordance with yet another embodiment, the warning mechanism 250 may include an ultrasonic transmitter instead of a radio frequency transmitter. The resulting system would work much the same way as the system 500 of FIG. 5, except that the actuator would be sensitive to an ultrasonic signal that is emitted by the ultrasonic transmitter when the leash 220 is nearing the defined maximum state of detraction.

In accordance with still another embodiment, the warning mechanism 250 may include an infrared emitter instead of a radio frequency or ultrasonic transmitter. The resulting system would work much the same way as the system 500 of FIG. 5, except that the actuator would be sensitive to an infrared signal that is emitted by the infrared emitter when the leash 220 is nearing the defined maximum state of detraction.

In yet another embodiment, the actuator may be configured to apply a stimulus (including e.g., an electrical shock, a prick, and other stimuli) to the dog upon receiving an activating signal. The activating signal may be transmitted wirelessly to the actuator, or via wired means through the leash 220, for example, in accordance with various embodiments.

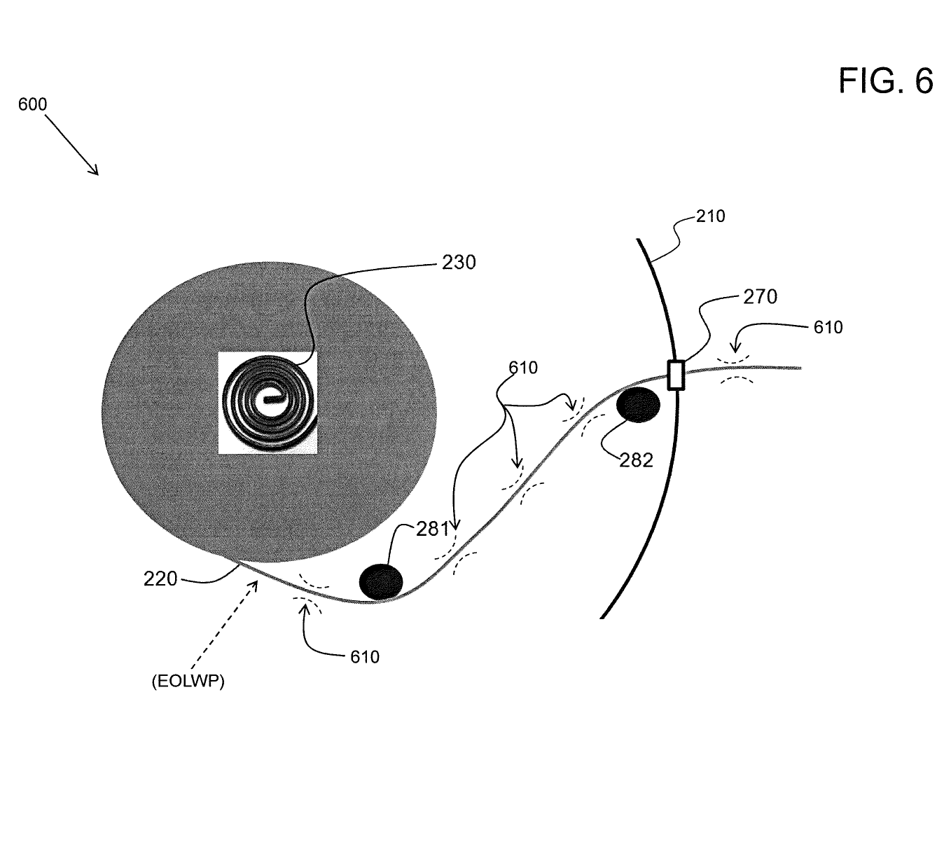

FIG. 6 illustrates a portion of a second example embodiment of a retractable dog leash apparatus 600. The leash apparatus 600 is similar to the leash apparatus 200 of FIG. 2 except that the leash apparatus 600 does not include a pressure sensor or a sonic, radio frequency, or infrared emitter of any kind In the embodiment of FIG. 6, the spring component 230 (e.g., a spiral torsion spring) builds up stored energy due to rotation as the leash 220 is detracted from the housing 210. Once the EOLWP is reached (i.e., when the leash 220 is nearing the defined maximum state of detraction), the spring component releases the stored energy causing a mechanical vibration 610 to be propagated through the leash 220. The spring mechanism 230 is configured to temporarily decouple from the rotating mechanism of the apparatus 600 to release its energy upon reaching the EOLWP.

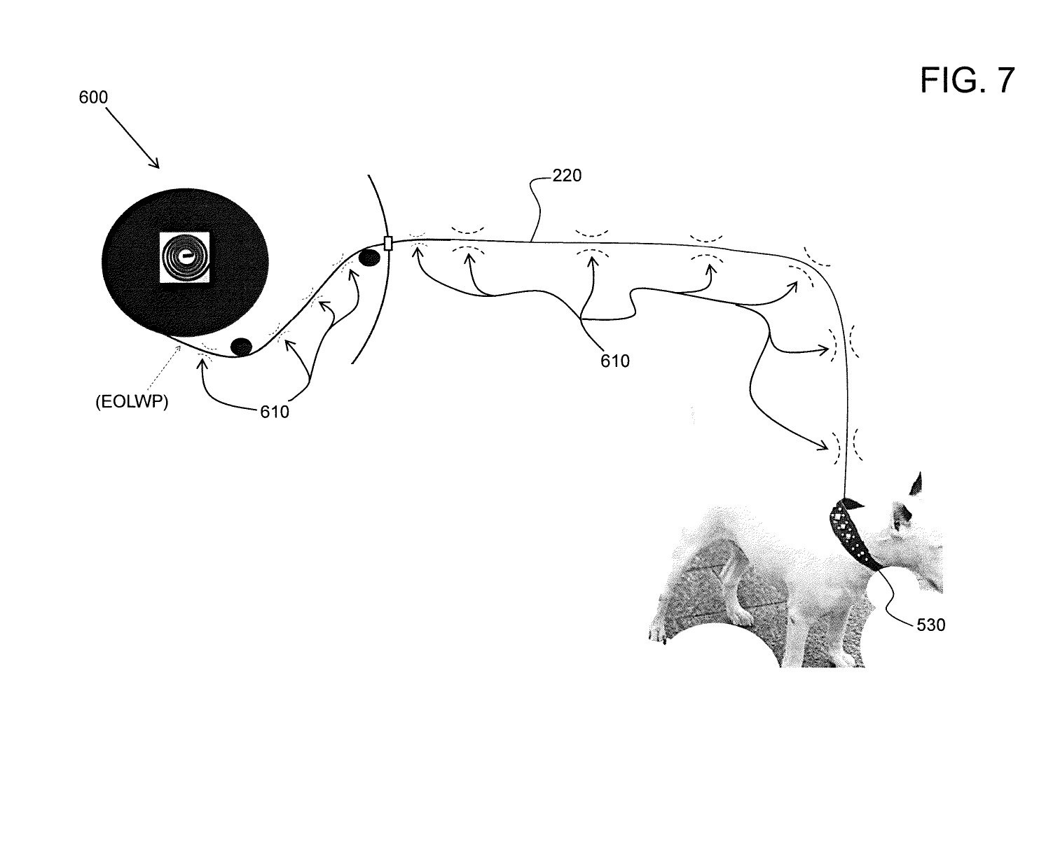

FIG. 7 illustrates the functional operation of the portion of the retractable dog leash apparatus 600 of FIG. 6 when a leash 220 of the retractable dog leash apparatus 600 is connected to a collar 530 worn by a dog. The mechanical vibration 610 propagated through the leash 220 is felt by the dog, providing an indication to the dog that the leash 220 is nearing the defined maximum state of detraction, causing the dog to stop or back off from pulling on the leash. Again, after several walks with the dog using the apparatus 600, the dog will train and react to the mechanical vibration in the leash to avoid being jerked and/or choked by the leash running out. Such an embodiment is purely mechanical and does not require any electrical components or sources of electrical power.

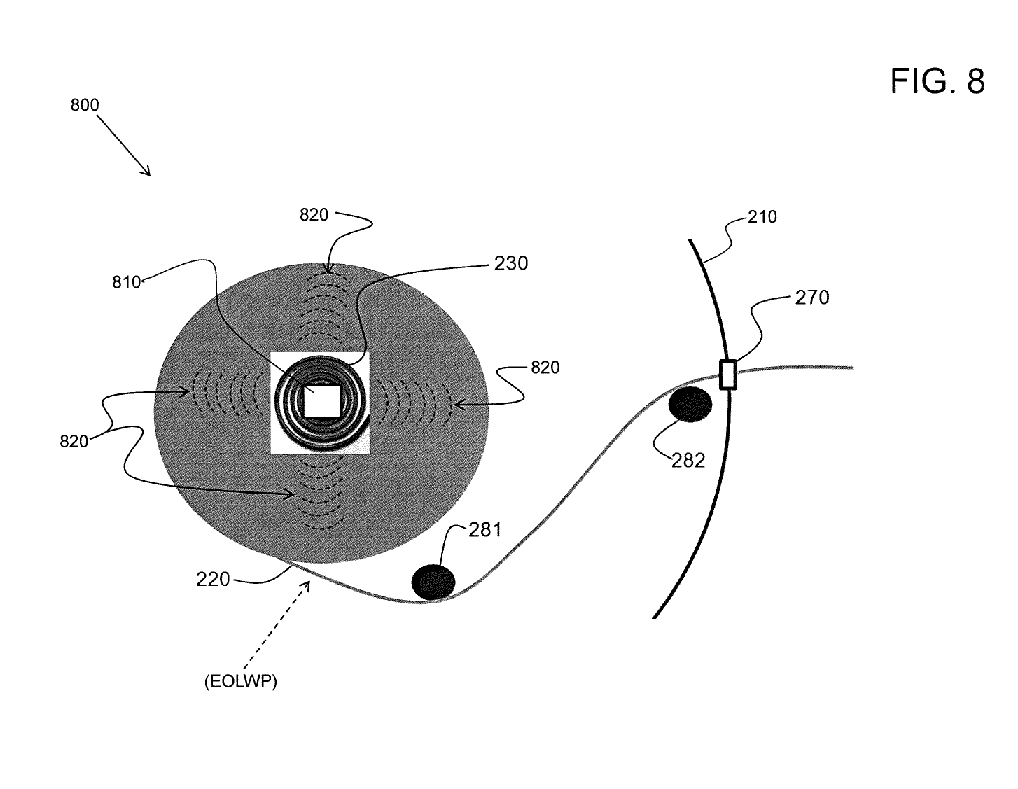

FIG. 8 illustrates a portion of a third example embodiment of a retractable dog leash apparatus 800. The leash apparatus 800 is similar to the leash apparatus 600 of FIG. 6 except that the leash apparatus 800 does not propagate a mechanical vibration through the leash 220. Instead, the leash apparatus 800 includes a rattle component 810 operatively connected to the spring component 230. In the embodiment of FIG. 8, the spring component 230 (e.g., a spiral torsion spring) builds up stored energy due to rotation as the leash 220 is detracted from the housing 210. Once the EOLWP is reached (i.e., when the leash 220 is nearing the defined maximum state of detraction), the spring component 230 releases the stored energy causing the rattle component 810 to make a rattling sound 820 in response to the stored energy being released. The spring mechanism 230 is configured to temporarily decouple from the rotating mechanism of the apparatus 600 to release its energy upon reaching the EOLWP.

The rattling sound 820 is heard by the dog, providing an indication to the dog that the leash 220 is nearing the defined maximum state of detraction, causing the dog to stop or back off from pulling on the leash. Again, after several walks with the dog using the apparatus 800, the dog will train and react to the rattling sound 820 to avoid being jerked and/or choked by the leash running out. Such an embodiment is purely mechanical and does not require any electrical components or sources of electrical power.

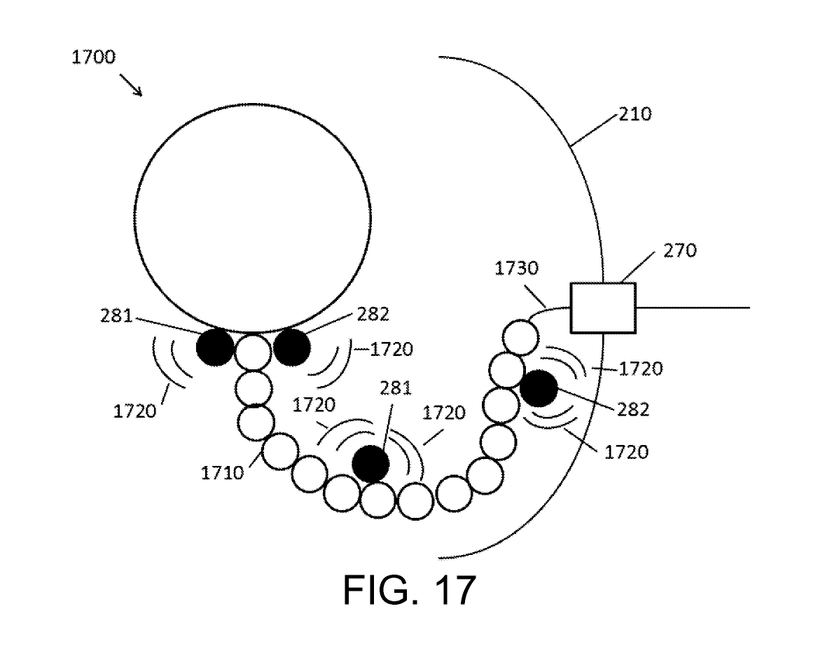

FIG. 17 depicts an alternate embodiment of a retractable dog leash apparatus 1700. The apparatus 1700 includes a leash 1730 with a secondary portion 1710. When the leash 1730 is nearing the defined maximum state of detraction, the secondary portion 1710 of the leash 1730 will come into contact with one or more roller guides 281 and 282 thereby forming a friction component. The secondary portion 1710 may include a beaded length or cable, ball-link or ball-chain, ellipse, diamond, zig-zag, or other types of configurations that will allow the secondary portion 1710 to form a friction component with roller guides 281 and 282. The friction component may produce a frictional sound and/or vibration 1720. Such a frictional sound and/or vibration 1720 may be produced as the leash 1730 nears any state of detraction including, but not limited to, fifty (50%) percent, seventy-five (75%) percent, or ninety (90%) percent. The frictional sound and/or vibration 1720 may be felt and/or heard by a person holding the leash apparatus 1700, the dog, or both. The frictional sound and/or vibration 1720 will not only alert the person that the leash 1730 is nearing the defined maximum state of detraction, but it will also alert the dog, which may cause the dog to stop or back off from pulling the leash 1730. After several walks with the dog using the apparatus 1700, the dog will train and react to the frictional sound and/or vibration 1720 to avoid being jerked and/or choked by the leash 1730 running out. While four roller guides 281 and 282 are shown in FIG. 17, it is to be understood that any number of roller guides in any number of arrangements may be included within the leash apparatus 1700, including, but not limited to, inside or adjacent to the port 270.

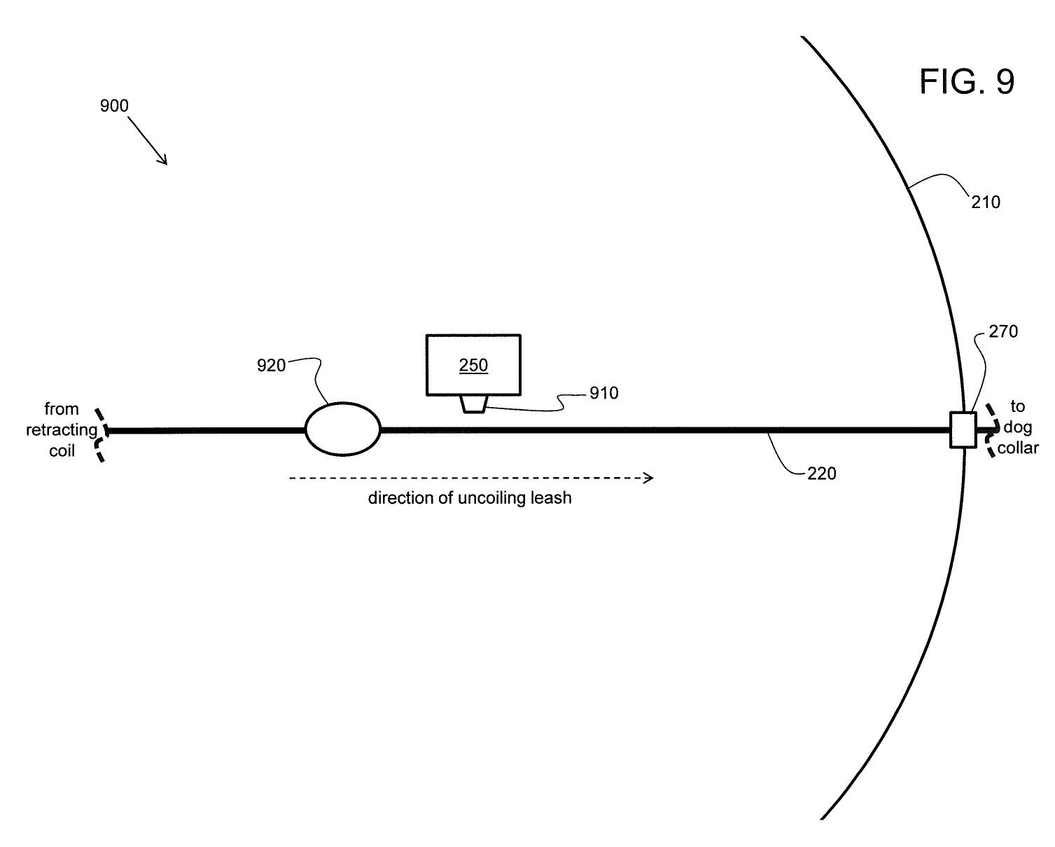

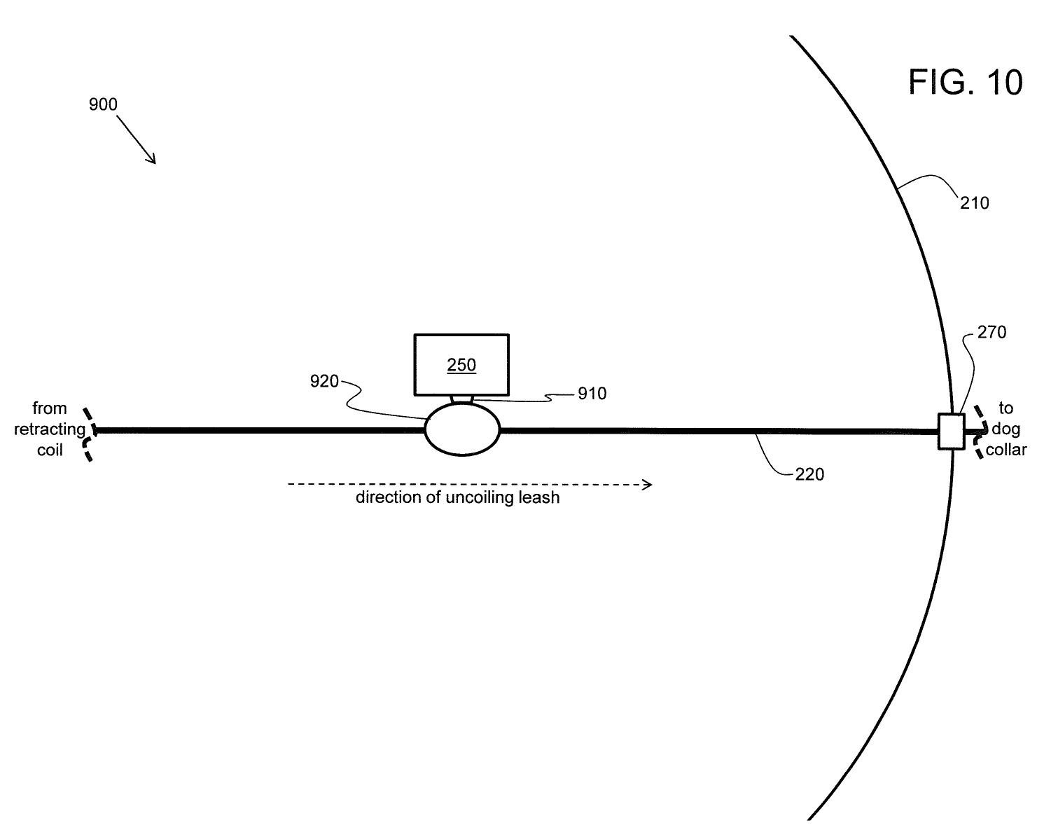

FIG. 9 illustrates a portion of a fourth example embodiment of a retractable dog leash apparatus 900. The apparatus 900 includes a switching mechanism 910 operatively connected to a warning mechanism 250. Again the warning mechanism 250 may emit a sonic signal, an ultrasonic signal, a radio frequency signal, or an infrared signal, for example, as previously described herein, in response to an activation signal from the switching mechanism 910. The switching mechanism 910 may be a pressure sensitive switching mechanism, a toggle switching mechanism, or some other kind of switching mechanism, in accordance with various embodiments. The apparatus 900 also includes a bulb mechanism 920 operatively attached to the leash 220. The bulb mechanism 920 may be a plastic knob or clasp, for example. The attachment of the bulb mechanism 920 to the leash 220 defines a EOLWP. When the leash 220 is being uncoiled (see direction of uncoiling leash in FIG. 9) due to, for example, a dog pulling on the far end of the leash, the bulb mechanism 920 on the leash 220 will eventually reach the switching mechanism 910 as shown in FIG. 10.

FIG. 10 illustrates the portion of the retractable dog leash apparatus 900 of FIG. 9 showing how the bulb mechanism 920 interacts with the switching mechanism 910. The bulb mechanism 920 and the switching mechanism 910 are configured such that the bulb mechanism 920 triggers the switching mechanism 910 when passing by the switching mechanism 910. When the bulb mechanism 920 reaches the switching mechanism 910 and triggers the switching mechanism 910, the switching mechanism 910 sends an activation signal to the warning mechanism 250. The warning mechanism 250 may act in accordance with previous descriptions of the warning mechanism 250 herein, providing an indication to the dog and/or the human that the leash is about to run out.

In accordance with an embodiment, when the leash 220 is retracted such that the bulb mechanism 920 passes by the switching mechanism 910 again, but in the opposite direction, the switching mechanism 910 is reset (e.g., toggled back to its original position) and the warning mechanism 250 is deactivated. In other embodiments, the warning mechanism 250 may be active for a defined period of time, after which the warning mechanism 250 automatically turns off, and the switching mechanism 910 may automatically reset.

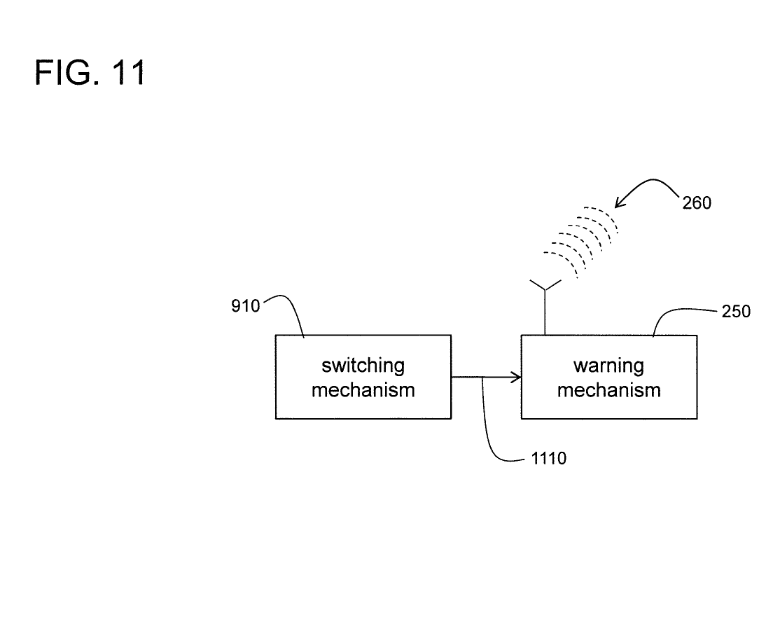

FIG. 11 illustrates a schematic block diagram of an embodiment of a portion of the retractable dog leash apparatus 900 of FIG. 9 and FIG. 10. The switching mechanism 910 is operatively connected to the warning mechanism 250 such that the switching mechanism 910 outputs an activating signal 1110 (e.g., an electrical signal) to the warning mechanism 250 when the leash 220 is nearing a defined maximum state of detraction (i.e., when the bulb mechanism 920 passes by). The warning mechanism 250 may output, for example, a sonic signal, a radio frequency signal, or an infrared signal, as previously described herein. The sonic signal may be audible to only humans, only dogs, or to both humans and dogs. Alternatively the sonic signal may be an ultrasonic signal used to activate an actuator 520 on a collar 530 of a dog, as previously described herein. Similarly, the radio frequency signal or the infrared signal may be used to activate an actuator 520 on a collar 530 of a dog, as previously described herein.

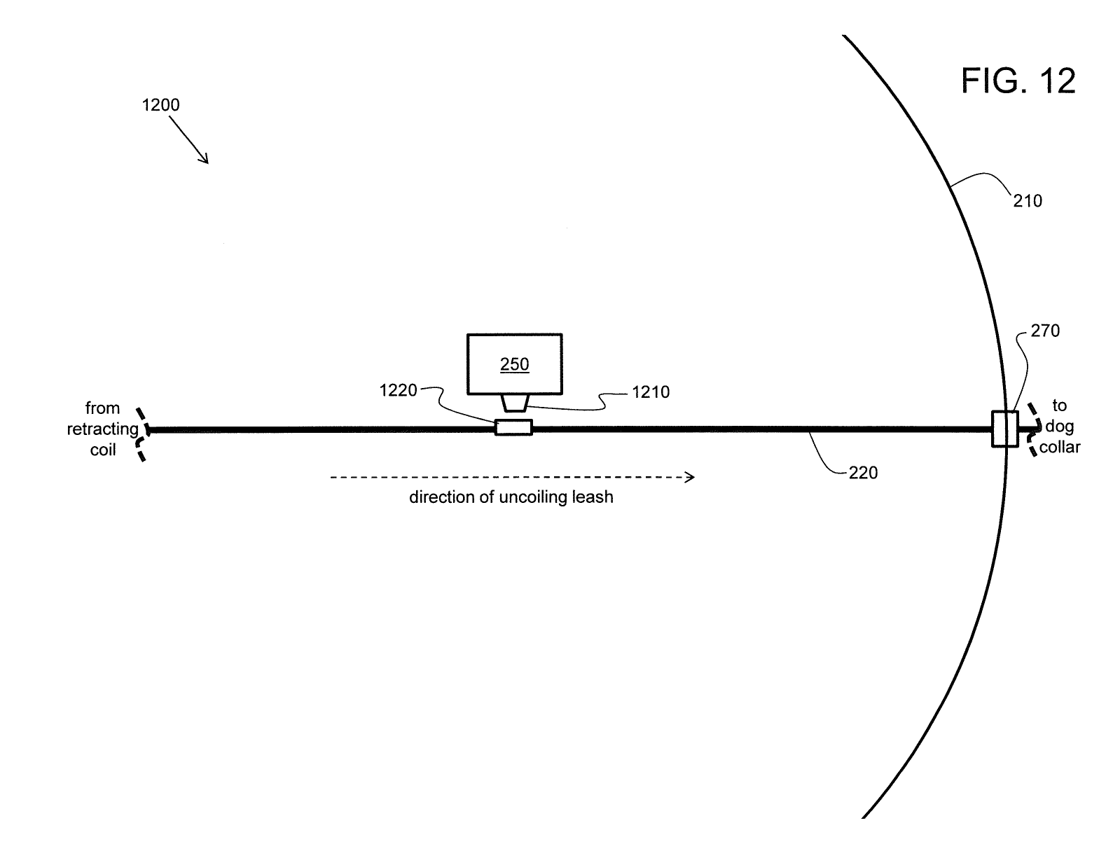

FIG. 12 illustrates a portion of a fifth example embodiment of a retractable dog leash apparatus 1200. The apparatus 1200 includes a sensing mechanism 1210 operatively connected to a warning mechanism 250. Again the warning mechanism 250 may emit a sonic signal, an ultrasonic signal, a radio frequency signal, or an infrared signal, for example, as previously described herein, in response to an activation signal from the sensing mechanism 1210. The sensing mechanism 1210 may be a magnetic sensor, an optical sensor, a radio frequency identification (RFID) sensor, or some other kind of sensing mechanism, in accordance with various embodiments. Further, the sensing mechanism may be unrelated to pressure. For example, an optical sensor may measure the length of leash 220 that has exited the housing 210. Further, the length of leash 220 may be measured using markings, symbols, colors or various textures such as cross-hatching on the leash 220 to signify different portions of the leash 220. Additionally, an optical sensor may measure the length of the leash 220 that has exited the housing 210 through magnetic or electrically conductive materials either on or in the leash 220 in order to indicate the position of the leash 220 with respect to the housing 210. The apparatus 1200 also includes a tag 1220 operatively attached to the leash 220. The tag 1220 may be a magnetic tag, an optically encoded tag, an RFID tag, or some other type of tag, in accordance with various embodiments, where the tag 1220 is compatible with the sensing mechanism 1210. The attachment of the tag 1220 to the leash 220 defines a EOLWP. The tag 1220 may be attached to the leash in any of a number of ways including, but not limited to, glueing, sewing, riveting, etc. Alternatively, in some embodiments, the tag may be embedded in the leash or be an integral part of the leash.

When the leash 220 is being uncoiled (see direction of uncoiling leash in FIG. 12) due to, for example, a dog pulling on the far end of the leash, the tag 1220 on the leash 220 will eventually reach the sensing mechanism 1210 as shown in FIG. 12. FIG. 12 shows how the tag 1220 interacts with the sensing mechanism 1210. The tag 1220 and the sensing mechanism 1210 are configured such that the sensing mechanism 1210 senses the tag 1220 when the tag 1220 passes by the sensing mechanism 1210. When the tag 1220 reaches the sensing mechanism 1210 and the tag 1220 is sensed, the sensing mechanism 1210 sends an activation signal to the warning mechanism 250. The warning mechanism 250 may act in accordance with previous descriptions of the warning mechanism 250 herein, providing an indication to the dog and/or the human that the leash is about to run out.

In accordance with an embodiment, when the leash 220 is retracted such that the tag 1220 passes by the sensing mechanism 1210 again, but in the opposite direction, the sensing mechanism 1210 senses the tag 1220 again and deactivates the warning mechanism 250. In other embodiments, the warning mechanism 250 may be active for a defined period of time, after which the warning mechanism 250 automatically turns off.

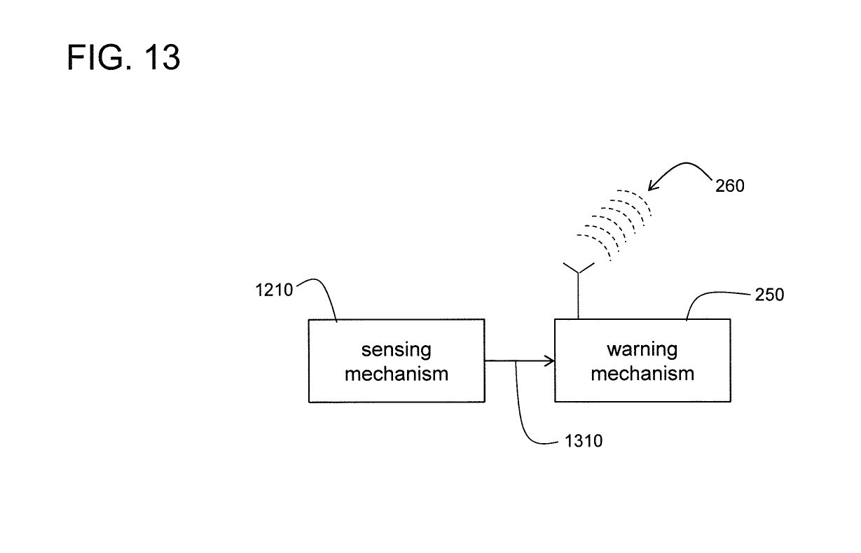

FIG. 13 illustrates a schematic block diagram of an embodiment of a portion of the retractable dog leash apparatus 1200 of FIG. 12. The sensing mechanism 1210 is operatively connected to the warning mechanism 250 such that the sensing mechanism 1210 outputs an activating signal 1310 (e.g., an electrical signal) to the warning mechanism 250 when the leash 220 is nearing a defined maximum state of detraction (i.e., when the tag 1220 passes by). The warning mechanism 250 may output, for example, a sonic signal, a radio frequency signal, or an infrared signal, as previously described herein. The sonic signal may be audible to only humans, only dogs, or to both humans and dogs. Alternatively the sonic signal may be an ultrasonic signal used to activate an actuator 520 on a collar 530 of a dog, as previously described herein. Similarly, the radio frequency signal or the infrared signal may be used to activate an actuator 520 on a collar 530 of a dog, as previously described herein.

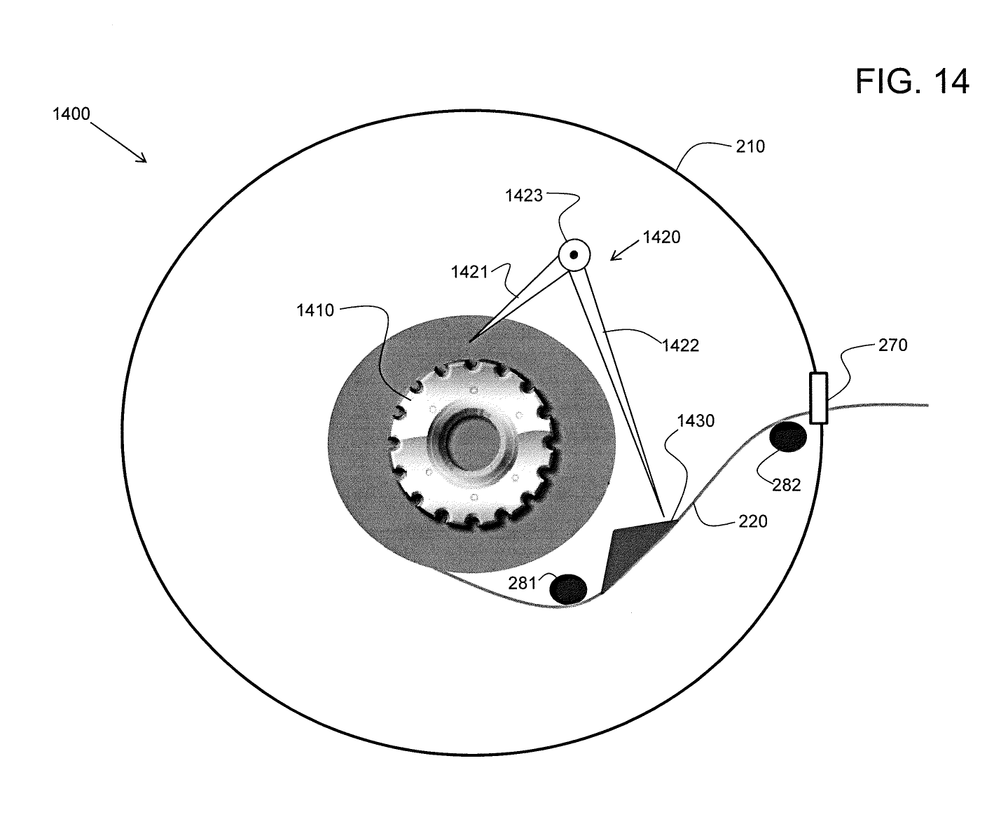

FIG. 14 illustrates a portion of a sixth example embodiment of a retractable dog leash apparatus 1400. The retractable dog leash apparatus 1400 is similar to the retractable dog leash apparatus 600 of FIG. 6 except that, instead of having a spring component 230, the apparatus 1400 includes a toothed component 1410, a lever mechanism 1420, and a trigger component 1430. The toothed component 1410 is configured to rotate as the leash 220 is detracted from the housing 210. The trigger component 1430 is attached to the leash 220 defining an EOLWP. The lever mechanism 1420 has a first arm 1421 and a second arm 1422 attached to a pivot point 1423. The trigger component 1430 may be a simple plastic triangular piece attached to the leash 220.

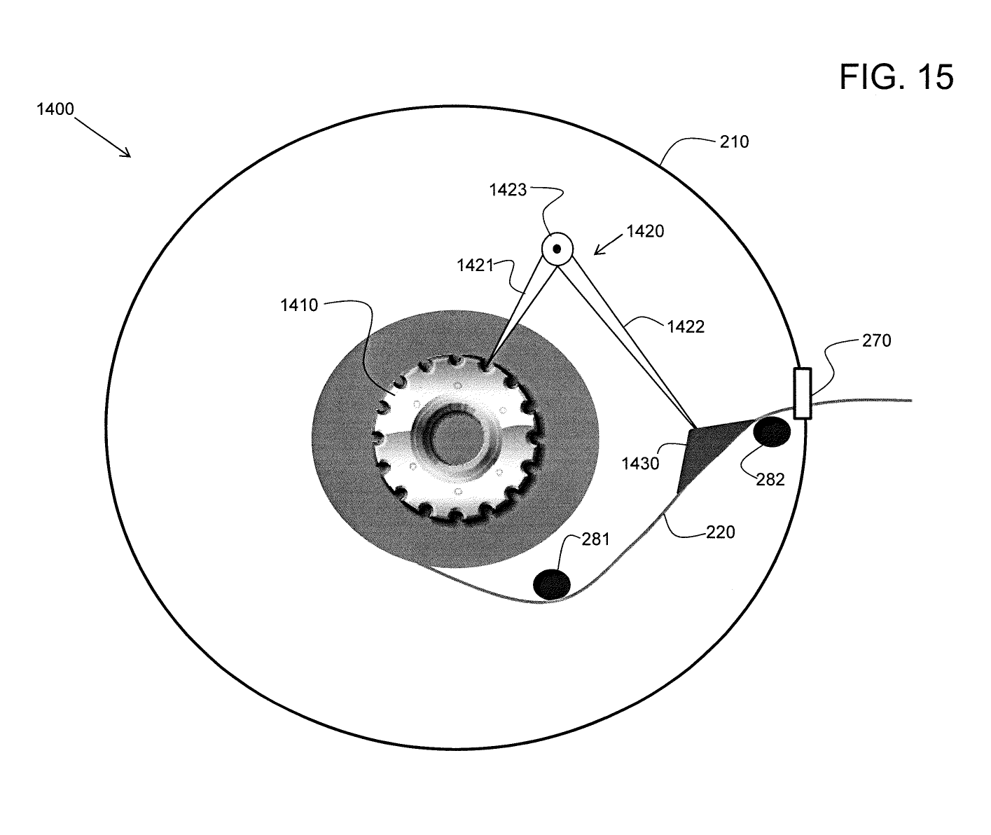

During operation, when the leash 220 is initially being detracted from the housing 210, the lever mechanism 1420 is disengaged from the toothed component 1410. However, as the EOLWP point is reached, the trigger component 1430 engages the second arm 1422 of the lever mechanism 1420, causing the lever mechanism 1420 to rotate around the pivot point 1423 such that the first arm 1421 engages the toothed component 1410. FIG. 15 illustrates the portion of the retractable dog leash apparatus 1400 of FIG. 14 showing how the trigger component 1430 interacts with the second arm 1422 of the lever mechanism 1420 as it passes by during detraction, and how the first arm 1421 of the lever mechanism 1420 engages the rotating toothed component 1410.

In one embodiment, when the first arm 1421 engages the rotating toothed component 1410, the engagement causes the toothed component 1410 to vibrate, causing a mechanical vibration to be propagated through the leash 220 in a similar manner to that of FIG. 6 and FIG. 7. The mechanical vibration propagated through the leash 220 is felt by the dog, providing an indication to the dog that the leash 220 is nearing the defined maximum state of detraction, causing the dog to stop or back off from pulling on the leash.

In another embodiment, when the first arm 1421 engages the rotating toothed component 1410, the engagement causes a clicking sound that can be heard by the dog. The clicking sound provides an indication to the dog that the leash 220 is nearing the defined maximum state of detraction, causing the dog to stop or back off from pulling on the leash.

Further embodiments of the invention of the present application may include audible speakers which may be located either in the collar, in the leash, in the housing 210, or at an external location of any of the components previously described in the specification. Further, an alarm may be included, which would allow a user to pick an audible sound from a variety of options. For example, a user may choose to pick a sound that the dog may acknowledge or other sounds with which the dog is familiar, including, but not limited to, the sound of an electric and/or invisible fence, or any other recognizable sound.

Still further embodiments of the invention of the present application may include wired embodiments allowing communication with any electronics that may be located either internally or externally on the dog's collar. In such embodiments, a wire is attached either inside or outside of the leash 220, which communicates either directly with an electronic located either internally or externally on the dog's collar.

The various embodiments described herein are examples of possible embodiments but are not meant to be limiting. Other embodiments falling within the scope of the appended claims are possible as well. For example, various other combinations of parts of the various embodiments described herein may be possible and fall within the scope of the appended claims. For example, in other embodiments, the configuration of the lever mechanism 1420 and the trigger component 1430 may be used to activate switches and/or electronics.

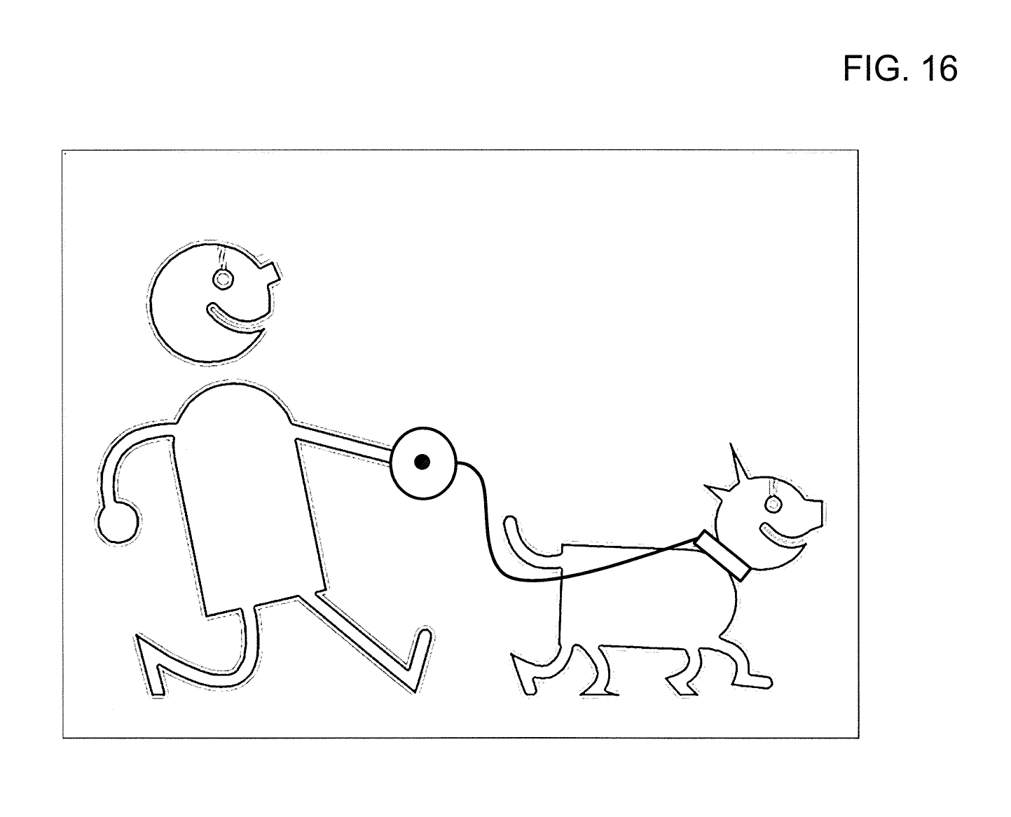

FIG. 16 illustrates a dog owner happily walking his dog using an embodiment of the invention of the present application. The dog is trained to respond to the warning signal by stopping or backing off from pulling on the leash so as not to jerk the arm of the dog owner or jerk and/or choke the neck of the dog.

In summary, an apparatus, a system, and a method for providing an end-of-leash warning are disclosed. Embodiments provide for determining when a retractable leash is about to reach a maximum state of detraction from a housing or reel mechanism as the leash is being detracted (e.g., by a dog), and generating a warning signal in response to determining when the retractable leash is about to reach the maximum state of detraction. The warning signal may be in the form of, for example, an emitted sonic signal, an emitted infrared signal, a transmitted radio frequency signal, or a mechanical vibration through the leash. The warning signal may be used to alert, for example, a dog and/or a person walking a dog that the leash is running out.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal language of the claims.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiments disclosed, but that the claimed subject matter will include all embodiments falling within the scope of the appended claims.

What is claimed is:

1. A system comprising:
a rotatable retracting mechanism;
a leash coiled around the rotatable retracting mechanism and configured to be uncoiled from and recoiled to the rotatable retracting mechanism;
an end-of-leash detection mechanism configured to determine when the leash is nearing a maximum uncoiled state as the leash is being uncoiled; and
a warning mechanism operatively connected to the end-of-leash detection mechanism and configured to generate a warning signal in response to the end-of-leash detection mechanism determining when the leash is nearing the maximum uncoiled state, wherein the warning signal is caused at least in part by a friction component.

2. The system of claim 1, wherein the warning signal further includes one or more of a mechanical vibration through the leash, an emitted sonic signal, an emitted infrared signal, and/or a transmitted radio frequency signal.

3. The system of claim 1, wherein the warning signal further includes an emitted sonic signal that is audible to dogs but not to humans.

4. The system of claim 1, wherein the end-of-leash detection mechanism includes a spring component and a pressure sensor, wherein the spring component is configured to apply a determined amount of pressure to the pressure sensor when the leash is nearing the maximum uncoiled state, and wherein the pressure sensor is configured to activate the warning mechanism upon sensing the determined amount of pressure.

5. The system of claim 1, further comprising an actuator configured to attach to a dog collar, wherein the actuator is configured to receive the warning signal and generate an emitted sonic signal in response to receiving the warning signal.

6. The system of claim 1, wherein at least a portion of the friction component is beaded.

7. The system of claim 1, wherein the end-of-leash detection mechanism includes a spring component and the warning mechanism includes a rattle component operatively connected to the spring component.

8. The system of claim 7, wherein the spring component is configured to build up stored energy as the leash uncoils in response to rotation of the rotatable retracting mechanism, and wherein the spring component is further configured to release the stored energy when the leash is nearing the maximum uncoiled state, and wherein the rattle component is configured to make a rattling sound in response to the stored energy being released.

9. The system of claim 1, wherein the end-of-leash detection mechanism includes:
a switching mechanism; and
a bulb mechanism attached to the leash, wherein the bulb mechanism on the leash is configured to activate the switching mechanism upon passing by the switching mechanism when the leash is nearing the maximum uncoiled state.

10. The system of claim 9, wherein the switching mechanism is operatively connected to the warning mechanism, and wherein the warning mechanism is configured to generate the warning signal in response to the switching mechanism being activated.

11. The system of claim 1, wherein the end-of-leash detection mechanism includes:
a sensing mechanism; and
a tag attached to the leash, wherein the tag on the leash is configured to be sensed by the sensing mechanism upon passing by the sensing mechanism when the leash is nearing the maximum uncoiled state.

12. The system of claim 11, wherein the tag includes one of a magnetic tag, an optically encoded tag, or a radio frequency identification tag.

13. The system of claim 11, wherein the sensing mechanism includes one of a magnetic sensor, an optical sensor, or a radio frequency identification sensor.

14. The system of claim 11, wherein the sensing mechanism is operatively connected to the warning mechanism, and wherein the warning mechanism is configured to generate the warning signal in response to the sensing mechanism sensing the tag.

15. An apparatus comprising:
a housing;
a cord residing within the housing;
means for facilitating detraction of the cord from the housing and retraction of the cord back into the housing;
means for determining when the cord is nearing a maximum state of detraction from the housing; and
means for generating a warning signal in response to determining when the cord is nearing the maximum state of detraction from the housing, wherein the warning signal is caused at least in part by a friction component.

16. The apparatus of claim 15, wherein at least a portion of the friction component is beaded.

17. The apparatus of claim 15, wherein the friction component includes a secondary portion which contacts one or more roller guides.

18. A method comprising:
determining when a leash is about to reach a maximum state of detraction from a reel mechanism as the leash is being detracted from the reel mechanism; and
generating a warning signal in response to determining when the leash is about to reach the maximum state of detraction from the reel mechanism, wherein the warning signal provides an indication that the leash is about to reach the maximum state of detraction from the reel mechanism, wherein the warning signal is caused at least in part by a friction component.

19. The method of claim 17, wherein at least a portion of the friction component is beaded.

20. The method of claim 17, further comprising transmitting at least a portion of the warning signal to an actuator device attached to a collar worn by a dog.
